(19) United States
(12) Patent Application Publication
(10) Pub. No.: US 2013/0038725 A1
(43) Pub. Date: Feb. 14, 2013

(54) HYPERSPECTRAL AND MULTIPLE IMAGING CONTROLLED ENCLOSURE FOR SAMPLE EXAMINATION

(71) Applicants: Mark Allen Lanoue, Long Beach, MS (US); Janek Kaliczak, Aptos, CA (US)

(72) Inventors: Mark Allen Lanoue, Long Beach, MS (US); Janek Kaliczak, Aptos, CA (US)

(73) Assignee: Mark Allen Lanoue, Long Beach, MS (US)

(21) Appl. No.: 13/206,082

(22) Filed: Aug. 9, 2011

(51) Int. Cl. H04N 7/18

(52) U.S. Cl. 348/143; 348/E07.085

(57) ABSTRACT

The invention pertains to the creation of an enclosed hyperspectral and/or multispectral and/or ultraspectral and/or full spectrum and/or full frame and/or scanning imaging device that will use a multitude of spectral ranges, fluorescence features, polarized filtration, zoom lenses, and con-focal capabilities. The system would also have related imaging attachments, and triggered lights for multiple ranges, including UV, VNIR, SWIR and LWIR. The system collectively will be constructed so that it can hold 4 imaging devices. The system would have a high throughput and processing computer system with large volume data storage and redundancy in order to process large data loads quickly and efficiently. This system would be used to analyze explosives and/or other targets close up from large quantities to micro quantities and feature upgradeable transmission containers for imaging specific targets in their gaseous forms so that viable libraries and classification features can be constructed.

### CROSS REFERENCE TO RELATED APPLICATIONS

This patent is a continuation-in-part of application 61/331,429 filed May 5, 2010, entitled “Hyperspectral and Multiple Imaging Controlled Enclosure for Explosives and Target Development.” This patent has been incorporated for reference.

### FEDERALLY SPONSORED RESEARCH

Not Applicable

### SEQUENCE LISTING OR PROGRAM

Not Applicable

### BACKGROUND OF THE INVENTION

1. Field of the Invention

This application relates to the integration of multiple hyperspectral imagers, lighting and associated hardware in a sealed enclosure for sample examination.

2. Prior Art

The invention is mainly directed to a high spatial and spectral resolution hyperspectral imaging workstation that is capable of capturing hyperspectral images in the ultraviolet (UV), visible, very near infrared (VNIR), and short wave infrared range (SWIR) portions of the electromagnetic spectrum. In particular, the hyperspectral imaging workstation according to the invention includes sensors for acquiring separate image data sets in the 200-400 nanometer range (UV) 400-700 (Visible) in the 400-1000 (VNIR) and 900-2,500 nanometer (SWIR) ranges. The system is a complete enclosure that houses all of the necessary hardware including lighting, imagers, and hardware controls that can be self sufficient, enabling targeted substances under observation to be safely examined. The system according to the invention is capable of performing wavelength specific feature extraction and other spectral comparisons on the resulting data sets.

The present invention possesses many benefits and advantages over known single hyperspectral systems. By incorporating multiple imaging systems and associated controls in one sealed box, samples are able to be viewed in numerous light situations and camera configurations, and since the box is sealed, toxic substances can be viewed and analyzed without fear of contamination. The integrated software is able to take the information from the imagers and process and display an image in a relatively short amount of time. Because the computer is integrated into the system data is processed quickly and effectively. It is difficult to position the camera, lights and sample position, even in the best of circumstances. With this invention, multiple imagers, lights and the arrangement of sample position is controlled by a series of tracks controlled by integrated software.

Hyperspectral imaging, systems in general are known, and have been used for a diverse range of remote sensing and other analytical techniques, such as are disclosed, for example, in U.S. Pat. No. 5,790,188, to Xiuhong Sun, 1998 Aug. 4 and the related U.S. Pat. No. 6,211,906 to Xiuhong Sun, 2001 Apr. 3. Hyperspectral imaging has also been used in conjunction with microscopic optical systems, such as disclosed, for example, in U.S. Pat. No. 6,495,818 to Chengye Mau, 2002, Dec. 17. Dual systems are disclosed in U.S. Pat. Application No. 20090128802, Patrick, J et al, 2009, May 21, yet the pulsed laser doesn't cover the entire spectrum, and a near infrared camera and ambient light source to illuminate the sample and the spectrograph uses Raman to collect and analyze data. In such systems, radiation reflected by or emanating from a target or specimen is detected in a large number of narrow contiguous spectral bands, producing a data set which is distributed not only spatially, but spectrally as well. That is, for each pixel within an image of the target, information is recorded in each of the spectral bands, thereby producing a three-dimensional hyperspectral image cube, in which spectral information for each pixel is distributed across a spectral axis perpendicular to the spatial axis. In U.S. patent application Ser. No. 12/924,831 the system is enclosed and an image is generated by a SWIR hyperspectral imaging device and the camera, a RGB camera and other items that enable the “on the move” explosives detection as well as stationary. This device., although mobile does not provide a sealed environment for examining potentially dangerous substances, as well as the flexibility to choose any number of imaging devices that run the gamut from 200-2500 nm (UV-Shortwave Infrared). In addition, the light source used is tuned to emit one frequency, in a closed and multi-imaging device setup it is optimal to have one light source that can output light across the whole electromagnetic spectrum. Control rests on integrated components, which is essential for integrated operation.

Heretofore, no such workstation has been available which produces highly correlated contiguous spectral band data throughout a range from 200 to 2,500 nanometers; that is, including not only the SWIR range, but the UV and Visible ranges as well. In this cabinet four imaging sensors are seated. Other configurations, such as disclosed in U.S. Pat. Application No. US 2003/0123056, Barnes 2003, Jul. 3, use a mounted digital camera, a thermal sensor and calibrated light sources and radiometric correction. This setup is reasonable for detecting images in a specified spectral range, and with calibrated light sources, instead of full spectrum, images created in a wide spectrum, 200-2500 nanometer spectral range. In addition, capturing images using a digital camera is not desired in a precision system, which captures images using imaging systems and processed using a dedicated computer.

Accordingly, one object of the present invention is to provide a hyperspectral imaging workstation that includes sensors for acquiring separate image data sets in the ultraviolet, the visible and shortwave-infrared ranges of the electromagnetic spectrum.

Another object of the present invention is to provide a sealed system, accessible either directly or via the glove port. In a 4 camera system, integrated computer and associated devices and specialized software that control the unit physically and virtually through the manipulation and display software are not discussed previously in this exact configuration.

These and other objects and advantages are achieved by the imaging apparatus according to the present invention which includes UV, Visible and SWIR sensors together in a single enclosure. Each sensor captures an image of the target or specimen, resulting in respective UV, Visible and SWIR data sets which are then merged into a single imaging data set which includes highly correlated contiguous spectral bands throughout a range of from 200 to 2,500 nanometers, or are provided separately per end-user software settings.

In Patent Application US 2009/128802, Treado, 2009, May, 21, teaches a dual optical system and video capture device for detection of explosives and residue. The sample is excited by a pulsed Nd. YAG laser light source giving an output is plasma emitted photons at 1064 nm, a second wavelength of 532 nm for RAMAN scattered and illuminates the sample at a third wavelength of 266 nm to produce luminescence emitted photons. The device can detect samples above and beneath the ground.

Using a sealed, single light source with a spectrum of light output and 4 imaging devices that cover the entire spectrum generating a hyperspectral datacube for complete coverage of the entire spectrum and an image that is generated by utilizing one or many cameras to create an image is preferential to the above mentioned Patent.

U.S. Pat. No. 7,684,029, Tan, 2010 Mar. 23 teaches that multiple sensors can give you output that can then be used to codify data. However, ambient light is used and the sensors are tied to an emergency response system and produce output based on the ambient light situation. Not only do multiple sensors, tied to imaging devices produce high-quality data used in analysis, but the scope of this system is limited by its open environment. Closed, sealed, supplemental lighting provides a better environment for examining samples than open systems.

### SUMMARY OF THE INVENTION

An enclosed hyperspectral imaging device that will use a multitude of hyperspectral ranges, fluorescence features, polarized filtration, zoom lenses, and confocal capabilities. The system would also have related imaging attachments, and triggered lights for multiple ranges. This system would have a high throughput and processing computer system with a large volume data storage and redundancy in order to process large data loads quickly and efficiently. The system is setup to analyze samples close up from large quantities to micro quantities and later in gaseous forms so that viable libraries and classification features can he constructed. In addition, this system can be used to examine said micro-quantities of biological material, gaseous chemical components and trace chemicals. Utilizing the included components, libraries of items can be created and these libraries, databases and classification algorithms can then be used by this imaging enclosure as well as ultimately, hand held units in the field as well as to strengthen stand-off imaging procedures that are both new and existing.

The system according to one aspect of the invention permits the detection and analysis of small nuances and information that are otherwise undetectable in systems that use a wide swath filter. Also, the entire said range, from 200 to 2,500 nanometers can be used to identify pertinent wavelengths across a wide yet largely defined region of the electromagnetic spectrum for a wide variety of applications that can be programmed as algorithms within the system, or used to develop derivative systems. For example, certain inks that need to be defined when looking at genuine versus counterfeit documents may show regions of interest in both the UV and IR ranges, while others may be found within the visible portion of the electromagnetic spectrum.

Furthermore, in another aspect of the invention, the combination of a controlled lighting environment and the ability to use National Institute of Standards and Technology (NIST) traceable diffuse reflectance standards with each scan insures consistent and reproducible results.

The system according to the invention is run by a programmed data processor/software or computer that triggers the lights, hyperspectral cameras and computerized translation stage to acquire and process a fully explorable hyperspectral data cube. The translation stage moves beneath the sensors, allowing the line slit on the optical devices to acquire the entire target. The latter process is performed separately by both cameras, within separate ranges. Thereafter, the resulting data sets are combined in a known manner or provided separately per end-user software settings.

Other objects, advantages and novel features of the present invention will become apparent from the following detailed description of the invention when considered in conjunction with the accompanying drawings.

### BRIEF DESCRIPTION OF THE DRAWINGS

Some of the features, advantages and benefits of the present invention having been stated, others will become apparent as the description proceeds when taken in conjunction with the accompanying drawings in which:

FIG. 1 shows a imager stand inside the research cabinet according to the present invention;

FIG. 2 shows a imager stand with imagers mounted in the operational position;

FIG. 3 shows the imager stand with illumination lights in place on sliding tracks;

FIG. 4 shows a research cabinet external features and position of functional equipment;

FIG. 5 shows a system control flow chart;

FIG. 6 shows a typical hyperspectral imager with control functions illustrated;

FIG. 7A details showing locations for penetrating research box side walls

FIG. 7B imager armature location in cabinet

Drawings Reference Numerals

```
  8. top stop plate, stops imagaer movement beyond this point
  9. left structural side rail
10. right structural side rail
11. left vertical imager track
12. right vertical imager track
13. center verticle imager track
14. left camera mount
15. center camera mount
16. right camera mount
17. structural baseplate
18. sample stage
19. y direction of camera mount movement
20. x direction of movement of the camera mount movement
21. z direction of the camera mount movement
22. imager verticle track
23. left imager
24. right imager
25. center imager
26. x direction of movement of the entire system
27. y direction of movement of the ensire system
28. right light source
29. left light source
30. movement track of the left light
31. movement track of the right light
32. hyperspectral imaging external structure
33. airtight doors
34. keyboard, video display, mouse
35. computer
36. digital data storage
37. expansion for additional processors
38. locking casters
39. door lock
40. selection of imager
41. imager setup, depecting one of many
42. control of the position of the imagers
43. selecting and mounting the light source
44. positioning the light source
45. control of the stage
46. inserting and setting up a blocking filter
47. all items connected to a central computer for control
48. type of data storage
49. expansion room
50. a remote link from the system to the imaging box
51. keyboard, video display and mouse
52. initial focusing lens
53. second focusing lens
54. upper portion of the entrance slit
55. lower portion of the entrance slit
56. focal plane assembly
57. motion of the focal plane assembly
58. upper motion of the upper entrance slit assembly
59. lower motion of the entrance slit assembly
60. path light takes as it travels through the structure
61. spectograph
62. upper direction the light takes
63. lower direction the light travels
64. sensor array
65 entire sensor assembly that moves in relation to the wavelength of light
projected
66. motion of the spectograph assembly
67. inert gas and input location
68. space where imaging assembly resides
69. External glove mounting location
70. computer, system controls and human interface equipment location
71. main “box” body
72. imager armature, control motors, lighting equipment, control cable
interface to computer, system controls and human interface controls
(keyboard, video display, mouse) on lower portion of cabinet
```

### DETAILED DESCRIPTION

### Detailed Description of Embodiments

Reference will now be made to the detailed embodiment of the invention. The invention pertains to the creation of an enclosed hyperspectral and/or multi spectral and/or ultraspectral and/or full spectrum and/or full frame and/or scanning imaging device that will use a multitude of spectral ranges, fluorescence features, polarized filtration, zoom lenses, and con-focal capabilities. The system would also have related imaging attachments, and triggered lights for multiple ranges. This system would have a high throughput and processing computer system with large volume data storage and redundancy in order to process large data loads quickly and efficiently. This system would be used to analyze explosives and/or other targets close up from large quantities to micro quantities and feature upgradeable transmission containers for imaging specific targets in their gaseous forms so that viable libraries and classification features can be constructed. These libraries, databases and classification algorithms can then be used by hand held units (such as PDAs and PC tablets) in the field as well as to strengthen stand-off imaging procedures that are both new and existing.

The system collectively will be constructed so that it can hold multiple imaging devices (such as UV, VNIR, SWIR, LWIR). Each device will be on a separate up and down linear stage in order so that the system can be controlled for positioning to the target and will incorporate focus methodologies via software and hardware control and positioning. This focusing method will include standard focusing methods, manual focusing methods, and refined procedures using fine focus algorithms and lithography lines and/or focusing plates.

The device will be fully enclosed from the outside environmental concerns such as lighting, movement, shadows, etc. The imaging systems will be positioned to the front of the enclosure via a rotational stage controlled by the control software. All four linear stage positions will be mounted to and around the rotational stage. All transport ports will be assigned and mounted inside and outside of the enclosure in order to keep out the outside environmental factors. The system will use computer control in the form of large scale, small scale, and/or GPU and FPGA computer processing and control. The device will incorporate intelligent chip features in order to upgrade the classification and processing functionality of the device in order for the device to move from research mode to answer/classification mode. There will be a monitor, keyboard, pointing device. The system will incorporate calibration methodologies including LED, OLED, white reference, radiometric properties, and other standard calibration methodologies including but not limited to spheres, lasers, and reflective/diffusion targets.

The invention will have the imaging enclosure on top and the computer and storage located in the bottom section of the system.

The enclosure will have connection for exhaust fan, ozone eaters, coolant connections, and power. There will also be triggers for shutters and light sources.

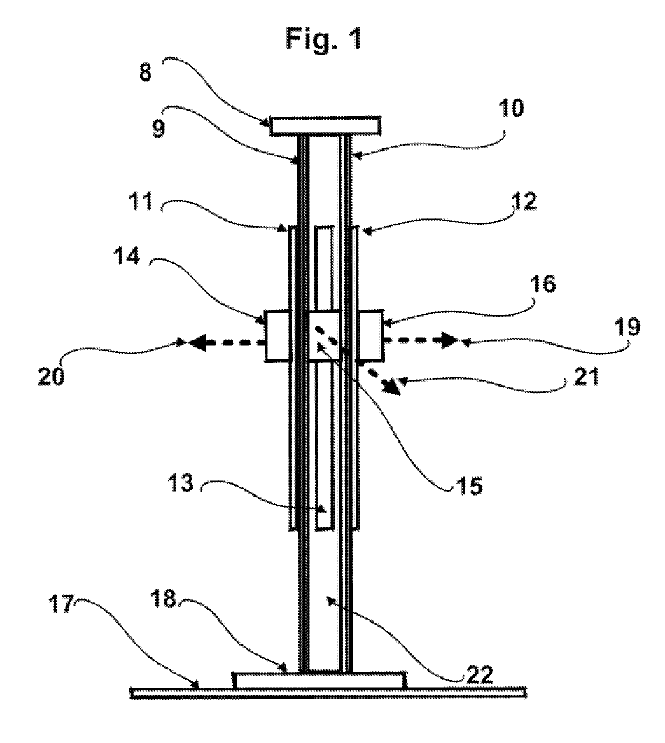

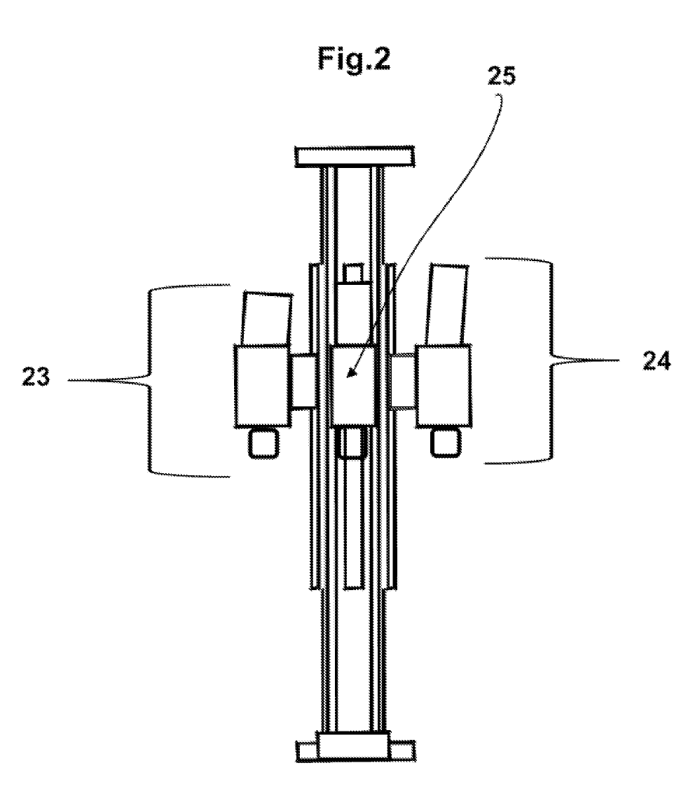

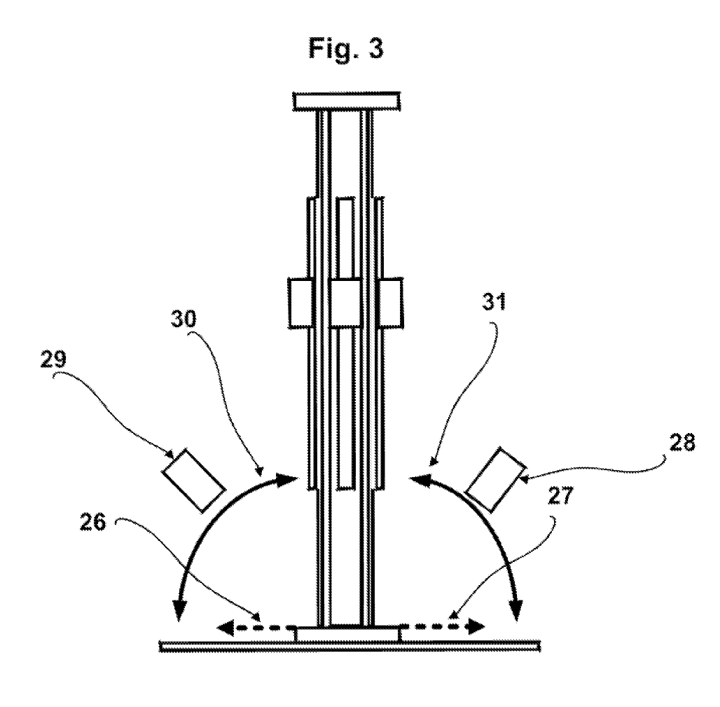

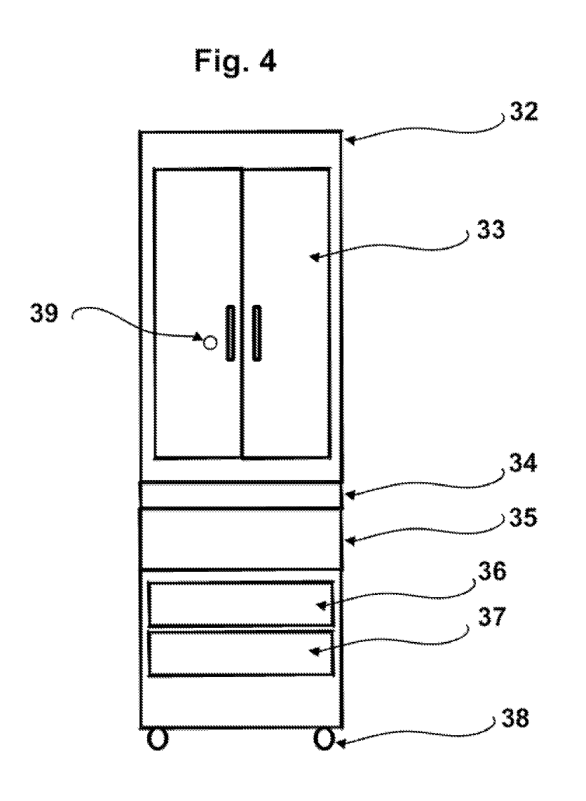

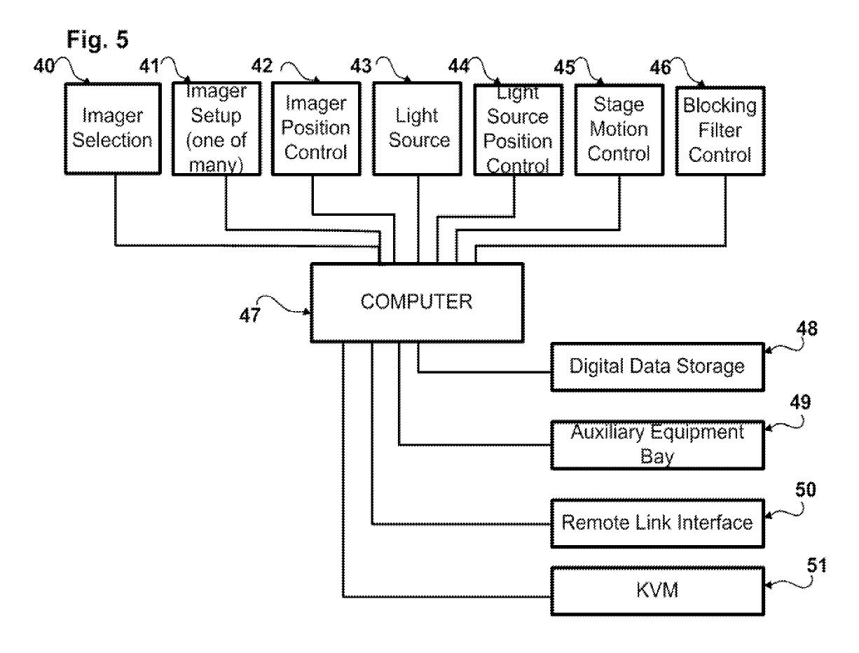

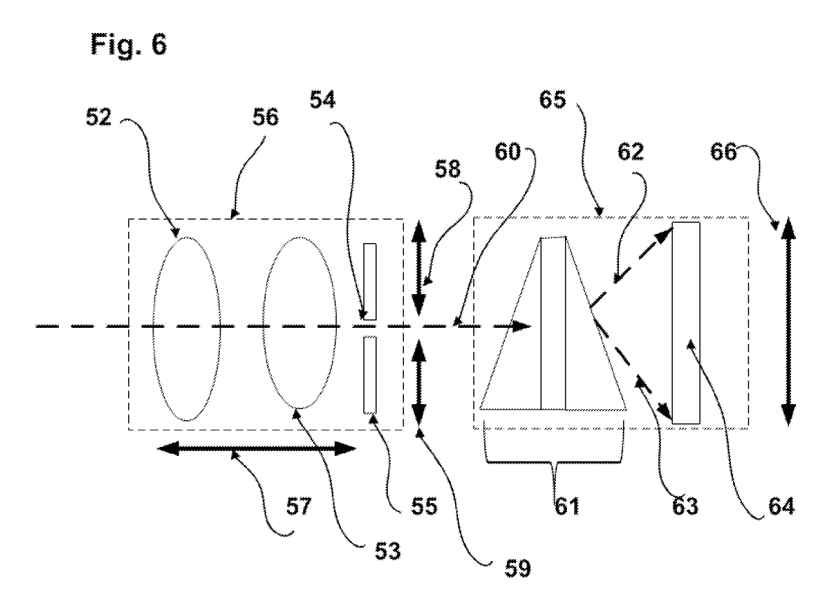

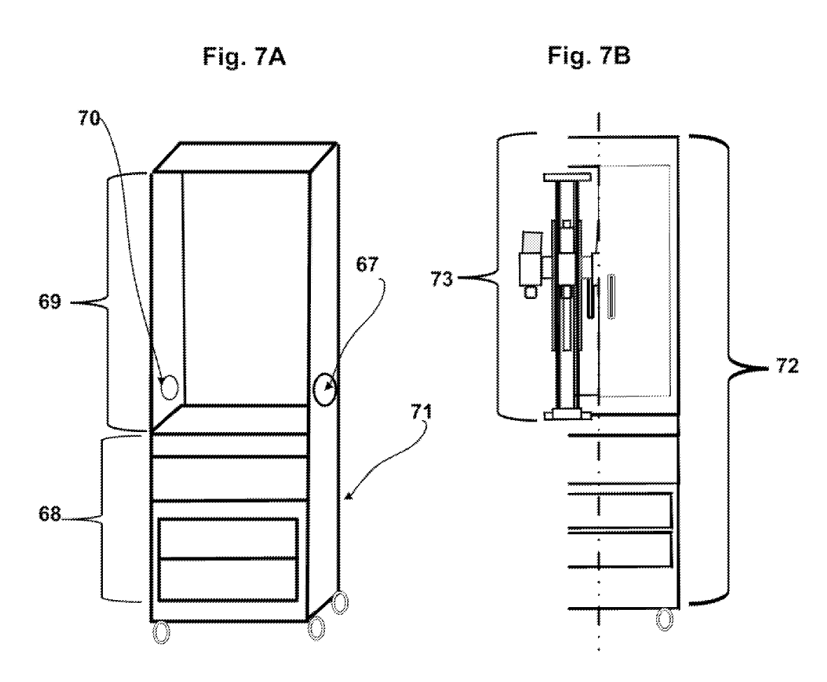

Now, referring to FIG. 1 is a schematic drawing of the internal parts of the enclosure. According to 8 (FIG. 1), the stop plate resides at the top of the setup preventing the parts of the unit from moving past a certain point. In 9 and 10 the side rail in enables movement of the entire unit. In 11 and 12, they depict the movement of the image assembly 23, 24, 25 (FIG. 2). The imaging assemblies move up and down a track, 9, 10 (FIG. 1) in order to adjust the height of the imagers in reference to the sample located on the stage 18 (FIG. 1). The imagers are mounted on a device 14, 15, 16 and move in such a manner, 19, 20, 21 so that each imager will have a swath in which to cover of the sample. Each imager, 25 (FIG. 2), can work independently and the entire assemblage can rotate 19, 20, 21 (FIG. 1). The specimen can be moved using a moving stage, 18, and brought into focus using focusing and assemblage movement. In order to properly position the imagers, there is a camera mount that moves in and out with respect to the entire assemblage. The imager baseplate 14, 15, 16, (FIG. 1), enables stabilization and proper positioning of the imager when it is moving. The baseplate is attached to the imager in such a manner that each imager is mounted precisely in position to image the sample. The baseplate is constructed for each different imager and placed in position where the particular imager will sit. Each imager can in succession image the sample, and using specialized software combines the images into one image. This specialized software includes the capability to manage all of the hardware controls inside the enclosure. Each component is handled separately and the data captured from the imaging devices is processed using specialized algorithms and other processing routines to enable the data to be captured and manipulated so that the end result is what the user expects; based on the parameters selected on the imagers and inside the control software. The software is designed to handle input from the imagers and other devices and control the movement of the components as well as their selected parameters and ultimately the output. In FIG. 3, the lighting portion of the workstation is depicted. In 19, 20, 21 (FIG. 1) the movement of the baseplate is indicated showing the movement of the entire assemblage relative to the baseplate. In 28, 29 (FIG. 3) the light source is delineated and its movement by 26, 27. There are two light sources that cover the spectrum from 200 nm-2500 nm. These lights move along a track, 30, 31 (FIG. 3), in order for the entire sample location to be illuminated. In FIG. 4 the external features of the system are presented. In 32, the top of the unit is indicated, yet it refers to the entire unit. In order to provide an airtight sealed environment, the doors in 33, lock using 39. It is necessary to control the entire unit externally, due to the sealed environment, so the keyboard, video display and mouse are located in the top tray of the cabinet 34 (FIG. 4), yet is connected to the assemblage via a sealed cable interface. The computer is located in 35, and controls the entire system via specialized software on the computer. The computer has enough storage and is fast enough to handle the load of data produced by the system. The storage unit, 36 is the digital data storage for the system. Item 37 is for future expansion and integration of faster and using technologically superior manners to process the data. The unit needs to be mobile in order to be available in any situation, so in 38, there is an example of the locking casters mounted on the system. Referring to FIG. 5, the diagram is an overall view of how the system works. It is a typical setup and can be changed in relation to needs and available technology. In relation to 40, the computer is connected to the entire system via integrated wiring and is the control unit for the entire system. It controls the motion of the imaging devices, lighting and motion of the different parts of the system such as the imaging assembly, lighting movement, sample movement and rotation and precise control of each separate imaging device in terms of wavelength of light to select and capture, the control of the focal plane shutter and the components inside the imaging device such as the spectrograph which move in concert up and down, and back and forth. In addition, the sensor and associated pixels capture the programmed wavelengths of light and produce a digital signal to the computer which receives the information and, with specialized software written specifically for this setup, produces information that can be manipulated and modified to produce a custom image. The computer is responsible for processing all of the data produced by the system. Using resident specialized algorithms and routines the computer breaks down this data into manageable chunks for the system to process. The computer can be a wide variety of types, and as technology progresses, the system will be updated. The system is fast, so data can be displayed as soon as the image is scanned. The entire keyboard, monitor and video device setup is integrated into the system, eliminating transfer speed issues. In reference to FIG. 5, 41, the primary duty is sensor setup. It is very important to select the proper sensors for the setup and to position and support it within the system. In 41 (FIG. 5), it is a representation of imager selection. This is important to ensure that the proper parameters chosen for each sensor are chosen. The imager illustrated in 25 (FIG. 2) is chosen based on its features included for the application, including the nanometer range; for instance the whole range from 200 nm-400 nm UV, up to SWIR 1000 nm-2500 nm. Each imaging device includes features found in standard hyperspectral, multispectral or ultraspectral imaging devices. The exception is the patented Articulated Focal Plane Shutter mechanism integrated into each system. This mechanism is different enabling movement of the slit in an x, y direction, moving the focus plane and moving the entire sensor body. In 19, 20, 21 (FIG. 1) the sensor position control is activated and moves the sensor to the right position for the type of sample imaged. The directions of movement are x and y, and z axis and around the z axis. In FIG. 3, 43 refers to the light source chosen for this system. The current light source is able to use one source for the whole range 200 nm-2500 nm. Other light sources can be integrated separately or together to provide the needed spectrum as noted above. Callout 26, 27 (FIG. 3) refers to the hardware and computer control needed to move the light source(s) in the x, y direction. This hardware includes motor control for both the lighting and 25 (FIG. 2) the imager. In 26, 27 (FIG. 3), the lighting control is carried out by motor controls and computer routines. In relation to 46 (FIG. 5), the Blocking Filter integrated into the system to control which spectral frequencies are sampled is also controlled by small motors located near the imaging device. In 47 (FIG. 5), a component of the computer is illustrated. This component, 48 is the storage portion of the computer. It can be any manner of storage digital or otherwise to store the data produced by the system. In 49, there is an auxiliary bay which can be used for further expansion of the system, based on current and future technology. In 50, the item refers to a remote link interface that connects the computer via USB, Firewire, Fiber or other high-speed interface. In 51, KVM refers to the Keyboard, Video system and Monitor. These ancillary, yet necessary devices and integrated interfaces provide the communication with the external environment. Referring to FIG. 6, this overall system is representative of the inside of an imager, 25 (FIG. 2). In 52, the fore lens is the first unit to receive the stream of light produced by shining the light at the sample and selectively routing the desired wavelengths of light through the imaging system. The light travels through the second lens 53, and through the slit, which has two parts, 54, 55 which move independently depending on the image desired and the wavelengths of light selected on the imaging systems. In 56 (FIG. 6) the entire front assembly is noted, enclosing 52, 53, 54, 55. This system constitutes the focal plane plus the noted lenses. In 57, the x,y direction of the focal plane armature movement is illustrated. The entire assembly can move back and forth as well as up and down, 58, 59. This movement is controlled by the hardware motors inside the enclosure as well as by the computer with the specialized software installed. In 60, the direction the light takes is illustrated. The spectrograph, illustrated as a prism is noted in 61. As the light passes through the prism, it takes two different paths, 62, 63. The device that captured the electromagnetic radiation that has taken a long path through the system is captured by an array, be it a CCD array, sCMOS, carbon nanotube or other light collecting and translating device. The array takes the electromagnetic radiation and converts it to a digital signal that the computer can understand. This information is processed and manipulated by the software and displays the result on the attached video device. The video device can be an external monitor or a laptop or other processing unit. The entire unit, the spectrograph and array are enclosed, 65 and can move in an up and down direction, 66. Referring to FIG. 7A, the figure depicts a view of the system as it would be without the imaging assembly inserted into the enclosure. In 67, the depicted circle represents the port through which gloves can be attached to operate in a sealed environment. In 68, the locations in which the computer, storage device, keyboard video monitor and expansion slot reside 34, 35, 36, 37 (FIG. 4). In 69, referring to the upper portion of the imager enclosure where the imager resides. In 70, the port is where the inert gas is input and functions also as the exhaust port for the system. In 71, the location of the external shell of the research cabinet is depicted. In 72 the entire imaging enclosure is noted including the internal and external imaging portions. In 73, just the imaging portion of the research cabinet system is noted.

### Operation—First Embodiment

The internal working parts of the system (FIG. 1) function to move and rotate the different parts of the imaging infrastructure. The rails in (FIG. 1), 9,10 cause the imager mounting device assembly (FIG. 1) 10 11, 12 to move in an up and down manner. The imager mounts, 14, 15, 16 can rotate about the assembly, 19, 20, 21. All of this motion is to precisely move each camera and light (FIG. 3) 28, 29 into the correct location to examine the sample placed on the stage (FIG. 1) 18. The imagers are selected based on the desired spectral frequency range, not only of the end user, but as the sample dictates. The lights (FIG. 3) 28, 29, can provide light in the full frequency range eliminating the need for multiple lights, they also rotate in two directions (FIG. 3) 30,31 and 26, 27. By controlling the movement of the lights in this manner the setup can be precisely positioned illuminating the sample with the correct amount of light.

The movement of the components of the system is controlled by an integrated computer. This computer not only controls the hardware movements of the system, the software also processes the information gleaned from the imager scans and processes and analyzes it so that the image can be manipulated and viewed at the frequency that has been chosen by the user.

The imaging device performs all the functions that are needed for sample operation and analyization. The enclosure ensures that the sample environment is sealed and the samples are isolated. There are provisions for glove attachment (FIG. 7) 67,70 and exhaust venting.

Operation involves selecting the imaging devices and positioning them (FIG. 2) 23,34,25 on the rails (FIG. 1) 9,10 attaching them to 11,12, and rotating them 19,20,21 until they are at the right location for sample viewing. The lights (FIG. 3) 28,29 need to be moved into place 26,27,30,31. Then the computer (FIG. 4) 34, (FIG. 5) 47, needs to be moved into place and connected via a high speed connection. The other bays need to be filled (FIG. 4) 34,35,36,37,38 (FIG. 7A) 68 and (FIG. 5) 48,49,50,51, including the video device, mouse and keyboard (FIG. 5) 35.

The sample needs to be placed on the sample stage (FIG. 1) 18, and when everything has been positioned, the enclosure (FIG. 4) 32, (FIG. 7), 72 is sealed. The devices inside the enclosure can be positioned and manipulated based on the sample preparation and constitution in order to precisely examine the sample. The unit can be locked (FIG. 4) 39 to avoid any unauthorized entry. After precisely positioning the sample, the system is activated and using the specified spectral frequency, illuminated, scanned and an image is manipulated and displayed on the video monitor. Sample size is determined by the end user and it is possible to examine a gas sample due to the sealed nature of the system.

The entire system is designed to be a complete solution for imaging, for instance hyperspectral imaging with a range of UV to SWIR, sealed, user-defined positioning, computer and ancillary controls and a unique design for manipulating the imaging and specialized lighting devices within the enclosure.

### ADVANTAGES

From the above embodiments, it becomes evident that a number of advantages become evident.
a) A single imaging device, such as a hyperspectral camera will lack the flexibility of a multiple imaging device system. Each individual camera is tuned to a specific range of electromagnetic radiation to which it is sensitive; for instance UV or SWIR. By using multiple imaging devices, the range is expanded and the range can now be from 200 nm-2500 nm. This covers the whole range, from UV to SWIR.
b) The system is flexible different imaging devices can be chosen to either narrow or expand the nanometer range.
c) The imager consists of a multitude of devices to control every aspect of the system—camera control in three directions, lighting moving along a track, sample stage movement, movement of the focal plane and spectrograph assembly, integrated computer that controls all aspects of the system.
d) Fully airtight to enable dangerous as well as standard sample examination
e) Full spectrum lighting eliminating the need for multiple lights for different portions of the spectrum.
f) Completely integrated with all aspects that a multi-imaging system requires
g) Based on new technology
h) Existing systems can be integrated

### CONCLUSIONS, RAMIFICATIONS, SCOPE

Accordingly, the reader will see that the complete research cabinet offers the advantage of a unique design for the imaging unit which provides movement of the imagers and lights in a multitude of directions as controlled by specialized software and an integrated computer housed in the enclosure.

The imagers are flexible—they are chosen based on the application at hand. They can cover the range of UV to SWIR (200 nm-2500 nm). They are manufactured with state-of-the are sensors, including sCMOS and in the future carbon nanotubes. The movement of the focal plane and sensor assembly is under patent consideration.

The entire system is sealed enabling samples that run the gamut from explosives residue, gas, and biological samples. By integrating all of these functions, and using the locking casters, the system can virtually move anywhere these functions are needed.

Although the description above contains much specificity, these should not be construed as limiting the scope of the embodiments but as merely providing illustrations of some of the presently preferred embodiments. For example, as technology progresses the imager make up, shape, size and other parameters could change. In addition, the range of nanometers covered could expand. Specified lighting can be upgraded as well as the physical size and shape of the cabinet enclosure and internal workings for controlling the devices. The computer will be upgraded as well as the internal components of the imagers (FIG. 6).

1. An enclosed, sealed sample examination enclosure with multiple imaging devices;
a) A system that contains imaging platforms located in 4 controllable locations on linear stages that move up and down for optimal placement and controlled focus. The said four linear stages are connected to an encoded computer controlled rotational stage that allows for each one of the said computer controlled linear stages that position said imaging device at the front location known as the target imaging position at the front of the said enclosure.
b) A fully enclosed said system that controls and contains lighting for multiple ranges, fluorescence, calibration sources and standards, confocal, micro and macro lenses, and zooming methodologies;
c) A set of software controls that control the entire system all of said imaging devices and the methods developed for algorithm and classification output. The said software will also have a focusing methodology that will look for stretch methods for sharp edge focus using lithography plates and focus panels. The system will allow for normalization and calibration routines for comparable data;
d) The device will be tailored to image explosives in powder and gas form and will be designed to also image other target material with slight modifications.
e) The system will have an intelligent structure that will deal with upgradable; processing methodologies that allow the said system to be upgradable through the internet, wireless upload and cell communication. The intelligent chips will be pre loaded and/or flashable chips for the use of designed algorithms and methodologies;
f) The said computer is engineered to be paired with the system. In addition, the device contains bays that house the storage for the computer, video display and mouse and other expansion possibilities.
g) The internal portions of the light collecting device includes parts to acquire and pass on the light, scatter it and collect and pass on the signal to a collecting device where the signal is read by the computer and ultimately displayed as an image.
h) The said imaging devices are able to collect and process electromagnetic radiation from the UV (200 nm) to SWIR (2500 nm) and as technology progresses the range can expand.
i) The said sealed enclosure can accommodate specialized exhaust and glove ports.

2. The said sealed enclosure of claim 1 wherein the enclosure consists of a body, imaging devices, exhaust vents, controls for all aspects of said imaging devices and lights, a locking mechanism, and a computer controlled by said software.

3. The said sealed enclosure in claim 1 wherein the imaging platforms can be multi spectral, hyperspectral or ultraspectral imaging devices.

4. The sealed enclosure in claim 1 wherein stages move multidirectional up and down and rotationally.

5. The sealed enclosure in claim 1 is controlled by said computer which can be in virtually any configuration.

6. The sealed enclosure of claim 1 wherein the lighting is contained in said enclosure and can be moved with adjustable directionality.

7. The sealed enclosure of claim 1 wherein the software is specialized and its functions controlled by the user.

8. The sealed enclosure in claim 1 wherein a wide variety of samples can be imaged and processed

9. The sealed enclosure in claim 1 wherein the upgradeability of the said system can be remotely upgraded or physically modified dependent on the needs of the user

10. The sealed enclosure in claim 3 wherein the imaging platforms are mounted on a bi-directional, center rotational, device that accommodate movement and directionality

11. The sealed enclosure in claim 3 wherein the imaging platforms motion is controlled by specialized software integrated with the computer

12. The sealed enclosure in claim 6 wherein the lighting can be chosen from a wide variety of possible configurations that cover the associated electromagnetic spectrum range of the system.

13. The sealed enclosure in claim 7 wherein the specialized software is able to process the incoming light, manipulate the output and ultimately show it on a display device.

14. The sealed enclosure in claim 8 wherein the samples that can be used in the setup can be solid liquid or gaseous form.
